(19) United States
(12) Patent Application Publication
(10) Pub. No.: US 2007/0096455 A1
(43) Pub. Date: May 3, 2007

(54) Business Card Holder

(75) Inventor: Brett Heap, Santa Ana, CA (US)

Correspondence Address: Robert D. Fish;Rutan & Tucker, LLP, 611 ANTON BLVD, SUITE 1400, COSTA MESA, CA, 92626, US

(73) Assignee: FARHEAP SOLUTIONS, INC., Santa Ana, CA (US)

(21) Appl. No.: 11/556,534

(22) Filed: Nov. 3, 2006

Related U.S. Application Data
(60) Provisional application No. 60/733,699, filed on Nov. 3, 2005.

(51) Int. Cl. B42D 1/00

(52) U.S. Cl. 281/38

(57) ABSTRACT

A system and method is provided in which business cards are stored in pockets of a sheeted material. More specifically, the present invention relates to a business card holder wherein at least one of the pockets is positioned such that at least one of the cards is allowed to extend away from the pocket and to extend away from the outside edge of the material and/or the business card holder.

### PRIORITY CLAIM

This utility patent claims priority to the earlier filed provisional patent application entitled: Business Card Holder having a Ser. No. of 60/733,699 and filed on Nov. 3, 2005.

### FIELD OF THE INVENTION

The present invention relates to the field business cards. More specifically, the present invention relates to business card holders for display and storage thereof.

### BACKGROUND

Business cars have evolved over time from what are referred to as traditional trade cards and other identification cards, which allowed others to know the name and status of the card's owner. Early in the 15^{th} century in Asia and Europe, the idea of visiting cards was born. Typically, aristocrats, wealthy merchants and royalty would have these visiting cards delivered to their destinations and/or prospective hosts before their arrival at that destination and/or host. The purpose of these cards was to introduce the important delegate prior to their arrival and so that the host or recipient knew the social status of that individual to properly prepare for their arrival. These cards were a tool for protocol and etiquette which were used by aristocrats and other important individuals in trade.

Over time, these cards became an essential tool for upper and middle class individuals to identify social economic status and title. It allowed individuals to know to whom they were speaking and to what class that individual belonged.

Eventually, these cards became what we now know as business cards, which are used to identify the business, title, and individual name of the person working for that business. These business cards have become very important in some cultures to understand class and ranking within a socio-economic status. Additionally, business cards are important to individuals as a tool for reference and referral of information and services. Furthermore, the exchange of business cards has become essential for exchanging contact information, service disposal and position and ranking within an organization. Many cultures use the business card as a ranking system and status allocation system.

Individuals often receive business cards in their business meetings and travels, and storage of such cards can be problematic. For a relatively small number of cards, many individuals store the cards in pockets of a vinyl or other plastic page, which then fits into either a notebook or perhaps a manila folder. Of course, there are other solutions as well. It is known for example, for customers to store cards in a box, loose in a drawer, in a pocket of sheeted material (see e.g., http://www.shoplet.com/office/db/g2044447.html), or even in a mini file cabinet (see e.g., http://www.findgift.com/gift-ideas/pid-30402/).

When cards are received from the printer, there is of course no need to visualize individual ones of a set of 500 or more cards; the cards are all the same. In such circumstances it is usually convenient to store the cards in the small boxes in which they are typically shipped. These boxes usually offer very little visual aesthetics of the cards themselves. The individual will still be required to open the boxes to obtain the business cards when desired.

Additionally, many individuals have multiple business cards and/or may have very limited space in which to store the business cards. Many individuals may choose to store the their business cards in a filing cabinet. To that end it is known to store business cards in a bucket folder, which can be hanging or non-hanging. But that solution is anything but elegant, and can be inconvenient, especially where an individual has multiple business cards related to multiple different titles and capacities. Moreover, the individual must still tab the folder or sheet.

A need therefore exists for an improved business card holder. More specifically, a need therefore exists for an improved business card holder that allows for better storage and display of business cards. Additionally, a need exists for an improved business card holder having an edge that may stick out from the outside portion of the holder to allow the individual quick reference to the desired card or demographic of cards.

### SUMMARY OF THE INVENTION

The present invention provides systems and methods in which business cards are stored in pockets of a sheeted material. More specifically, the present invention relates to a business card holder wherein at least one of the pockets is positioned such that at least one of the cards is allowed to extend away from the pocket and to extend away from the outside edge of the material and/or the business card holder.

To this end in an exemplary embodiment of the present invention, a device for storage and display of an article is provided. The device has a sheet adapted for insertion of an article. Additionally, the device may have an article to be placed into the sheet of the storage and display device and a plurality of pockets contained on the sheet for reception of an article within the pockets of the sheet.

In an exemplary embodiment, the device may have a sheet wherein the sheet is constructed from vinyl.

In an exemplary embodiment, the device may have a sheet wherein the sheet is constructed of plastic.

In an exemplary embodiment, the device may have a sheet wherein the sheet is constructed of any suitable durable material wherein the material is transparent to allow for display and identification of the article contained within the pocket of the sheet.

In an exemplary embodiment, the device may have an article to be placed in the pocket of the sheet that is a business card.

In an exemplary embodiment, the device may have an article to be placed in the pocket of the sheet that is a pen, pencil, eraser or other article.

In an exemplary embodiment, the device may have a plurality of side holes on an edge of the sheet whereby the sheet is insertable into a standard three ring binder.

In an exemplary embodiment, the device may have an inside edge and an outside edge of the sheet wherein the outside edge of the sheet has a pocket located in close proximity thereto whereby when an article is inserted into the pocket, the article will extend outward, away from the outside edge of the sheet.

In an exemplary embodiment, the device may have a plurality of pockets wherein at least one pocket is located within close proximity to an outside edge of the pocket whereby with insertion of an article, the article will extend outwardly from the outside edge of the pocket and extend away from the outside edge of the sheet and thereby act as a tab for the sheet.

In an exemplary embodiment, the device may have a plurality of pockets that have an expansion means to accommodate larger articles.

In an exemplary embodiment, the device may have pockets on the sheet that may be configured in a plurality of configurations including horizontal placement, vertical placement and diagonal placement.

To this end, in an exemplary embodiment of the present invention, a method of using a business card holder is provided. The method comprises the steps of: providing a business card holder sheet adapted for insertion of an article wherein the sheet is constructed of vinyl and further wherein the sheet is transparent in nature; producing an article to be placed into the sheet of the business card holder; and providing a plurality of pockets contained on the sheet for reception of an article within the pockets of the sheet.

In an exemplary embodiment, the method of using a business card holder includes the step of: providing a plurality of pockets wherein at least one pocket is located within close proximity to an outside edge of the pocket whereby with insertion of an article, the article will extend outwardly from the outside edge of the pocket and extend away from the outside edge of the sheet and thereby act as a tab for the sheet.

In an exemplary embodiment, the method of using a business card holder includes the step of: providing an inside edge and an outside edge of the sheet wherein the outside edge of the sheet has a pocket located in close proximity thereto whereby when an article is inserted into the pocket, the article will extend outward, away from the outside edge of the sheet.

In an exemplary embodiment, the method of using a business card holder includes the step of: providing an expansion means for the pockets of the sheet whereby the expansion means allows for insertion of larger articles or a plurality of articles into the pockets.

In an exemplary embodiment, the method of using a business card holder includes the step of: inserting business cards into the pockets of the sheet of the business card holder.

In an exemplary embodiment, the method of using a business card holder includes the step of: providing a plurality of pockets wherein at least one pocket is located within close proximity to an outside edge of the pocket whereby a business card is inserted into the pocket in close proximity to the outside edge of the sheet wherein the business card extends outwardly from the outside edge of the pocket and extends away from the outside edge of the sheet and thereby acts as a tab for the sheet.

In an exemplary embodiment, the method of using a business card holder includes the step of: inserting a plurality of business cards into a pocket on the sheet.

In an exemplary embodiment, the method of using a business card holder includes the step of: removing a business card from the pocket when desired by the individual.

In an exemplary embodiment, an apparatus and method for an improved business card holder is provided.

In yet another exemplary embodiment, an apparatus and method for an improved business card holder is provided wherein the business card holder has a plurality of pockets contained thereon.

Still another exemplary embodiment is to provide an improved business card holder wherein the holder may have a plurality of pockets wherein in an embodiment, there may be twelve pockets.

Yet another exemplary embodiment is to provide an improved business card holder wherein the holder may have pockets sized and dimensioned to contain one or more business cards.

Another exemplary embodiment is to provide an improved business card holder wherein the holder may have a plurality of pockets to hold a plurality of business cards.

Still another exemplary embodiment is to provide an improved business card holder wherein the holder may have a plurality of pockets wherein at least one pocket is at an outside edge of the holder.

Another exemplary embodiment of the present invention is to provide an improved business card holder wherein the holder may have pockets on a front side and a rear side of the holder.

Yet another exemplary embodiment of the present invention is to provide an improved business card holder wherein the holder may have tabs to illustrate a specific section and/or designation for the cards in that section.

Still another exemplary embodiment of the present invention is to provide an improved business card holder wherein the holder may be sized and dimensioned to contain pens, pencils or any other suitable object to be held.

In another exemplary embodiment, an improved business card holder is provided wherein the holder may accommodate printed cards from an associated printer and further wherein the cards may be inserted by a mechanical element.

Another exemplary embodiment of the present invention is to provide an improved business card holder wherein the holder may be constructed from vinyl.

Yet another exemplary embodiment of the present invention is to provide an improved business card holder wherein the holder is constructed of plastic.

In yet another exemplary embodiment of the present invention, an improved business card holder is provided wherein the holder is made of any suitable resilient material.

Still another exemplary embodiment of the present invention is to provide an improved business card holder wherein the holder may be constructed of any transparent material.

Another exemplary embodiment of the present invention is to provide an improved business card holder wherein the holder may facilitate display of the business cards while protecting the same from outside elements.

Another exemplary embodiment of the present invention is to provide an improved business card holder wherein the holder may have a plurality of pockets that are constructed such that the associated placement of the business card will cause the card to extend away from the holder thereby making the card easier to read.

Yet another exemplary embodiment of the present invention is to provide an improved business card holder wherein the holder may have a tab thereon wherein the tab may facilitate easier display of specific guidelines, sections, or descriptions of the business cards that may be contained within the holder.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWINGS

FIG. 1 is a front view of the business card holder in an exemplary embodiment of the present invention;

FIG. 2 is a front perspective view of the business card holder in a binder format in an exemplary embodiment of the present invention;

FIG. 3 is a top view illustrating a plurality of business card holders in a binder in an exemplary embodiment of the present invention; and

FIG. 4 is another top view of the business card holder in an exemplary embodiment of the present invention.

### DETAILED DESCRIPTION

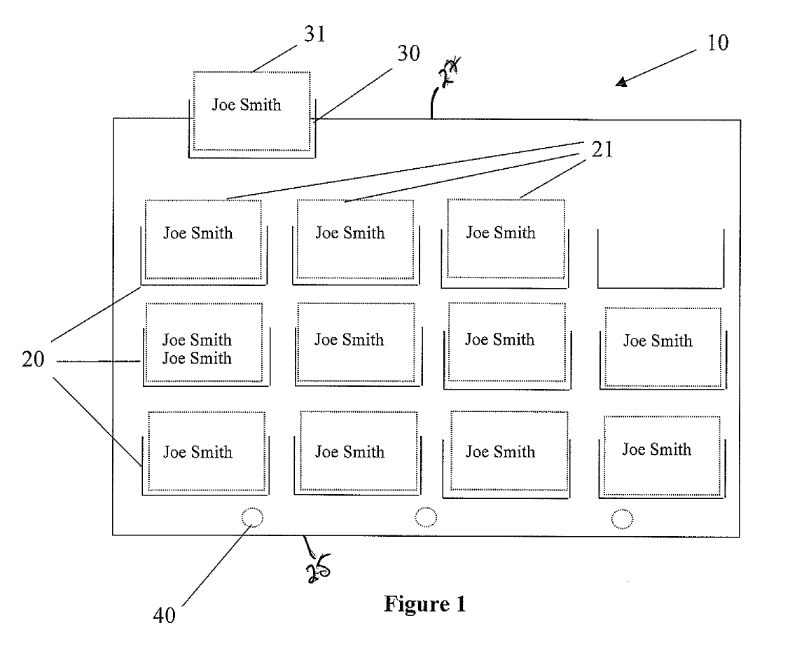

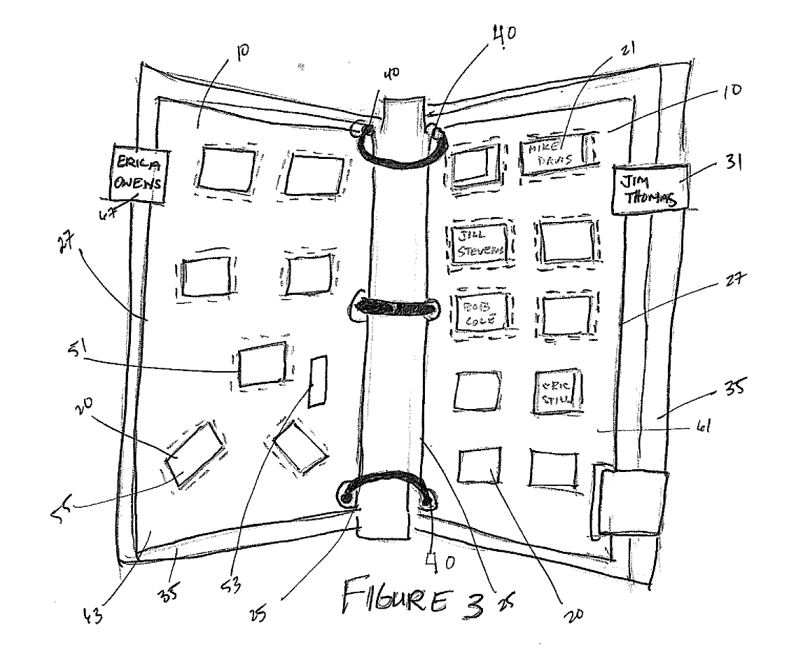

Turning now to the drawings wherein elements are identified by numbers and like elements are identified by like numbers throughout the 4 figures, FIG. 1, for example, illustrates a vinyl sheet 10 wherein the sheet 10 may have a plurality of pockets 20 contained thereon. In an exemplary embodiment, the sheet 10 may have twelve pockets 20. Each pocket 20 may be sized and dimensioned to contain and/or hold at least one business card 21 and in an exemplary embodiment, the pocket 20 may be dimensioned to contain a plurality of business cards 21. The sheet 10 may have a first inner edge 25 and a outside edge 27. The sheet 10 may also have a plurality of holes 40 thereon at a location near the first inner edge 25 for adaption and integration of the sheet 10 to a common three ring binder 35 (shown in FIG. 3). Additionally, near the outside edge 27 of the sheet, there may be another pocket 30, sized and dimensioned to hold another business card 31. The business card 31 may be positioned such that the card 31 extends away from the outside edge 27 of the sheet 10 thereby allowing the card 31 to also operates as a tab 37. However, it should be understood that the tab 37 may be completely unrelated to a card 31 and may be a conventional tab structure as seen in many other prior art references relating to tabs 37. In an exemplary embodiment, the sheet 10 may also contain optional three ring binder holes 40 whereby the ring binder holes 40 may be accommodated by the three ring binder 35.

The contemplated business card holder 1 can be sold separately as an article of commerce. The sheet 10 may be constructed of any suitable material. However, in an exemplary embodiment of the present invention, the sheet 10 may be constructed of vinyl. Additionally, in an exemplary embodiment, the sheet may be constructed of plastic, paper or any other resilient material that may be capable of holding a business card 21.

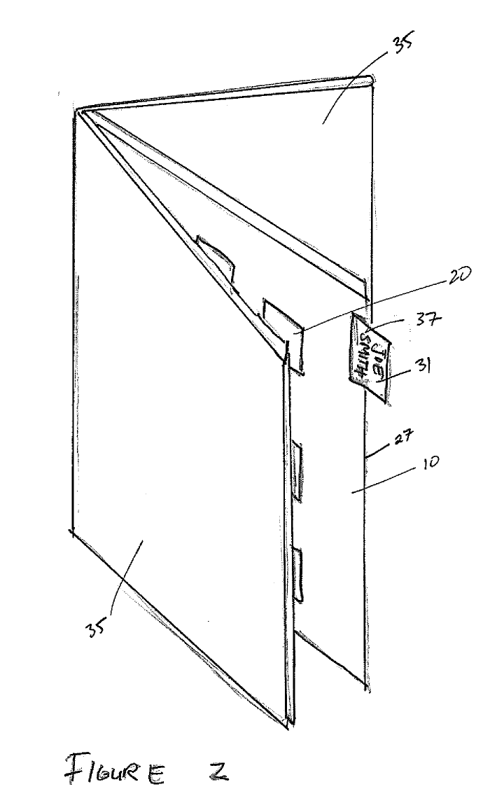

As illustrated in FIGS. 1-4, the sheet 10 may have a plurality of pockets 20 contained thereon. The pockets may have a standard configuration as illustrated in FIG. 1 such that the cards 21 are displayed in a horizontal 51 and/or vertical fashion 53. However, it should be understood that the business cards 21 may be adapted to the sheet 10 wherein the sheet 10 may have a plurality of different pockets 20 configurations as illustrated in FIG. 3, including diagonal configuration 55 and the like. It should also be understood that the sheet may have a greater or lesser number of pockets 20 than that shown,.

As illustrated in FIG. 3, the sheet 10 may have a plurality of pockets 20 wherein the pockets 20 may have a plurality of different configurations. Additionally, the sheets 10 may have holes 40 therein for adaptation and insertion into a standard three ring binder 35. Additionally, the sheets may also be adapted to have pockets 20 contained on a front side 61 of the sheet 10 and on a back side 63 of the same sheet. Thereby, the sheet 10 may have pockets 20 on one or both sides. Also illustrated in FIG. 3 is a pocket 67 that is positioned on an outside edge It is still further contemplated that the outside edge of the sheet 10 whereby a business card 31 may be positioned within the pocket 67 and extending away from the outside edge 27 of the sheet 10. The extending away of the business card 31 and/or other identification means, may allow for tabbing of the sheet 10 relative to other sheets 10 that may be contained within the same folder. Thereby, the accessibility of a certain page or specific sheet 10 may be easier for any user of the business card holder 1.

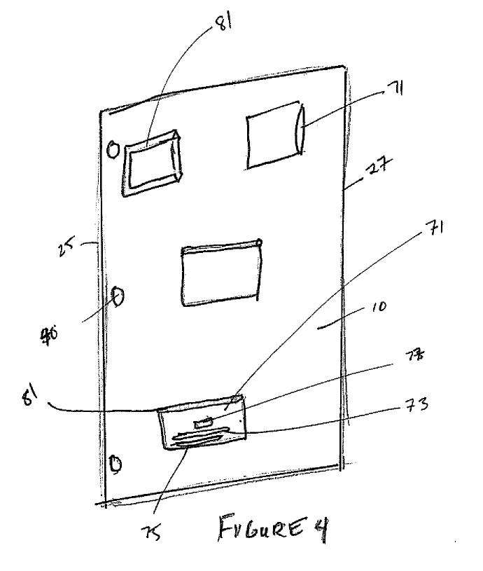

Moreover, as illustrated in FIG. 4, the sheet 10 may contain other pockets 71 which may be sized and dimensioned to contain other objects, such as pens 73, pencils 75 , erasers 77 and other types of objects for storage and display. Moreover, in an exemplary embodiment, the pockets 20 may be fashioned such that they are extendable and thereby allow for insertion of a plurality of business cards 21 in a singular pocket 20. The pockets 20 may have an expansion means 81 whereby the expansion means 81 allows for the opening of the pocket 10 to accommodate larger objects or a plurality of business cards if desired by an individual.

In another aspect of the invention it is contemplated that a business card printer (not shown) or distributor could insert new business cards 21 into the pockets 20 of the sheet 10 for delivery to their customers. This could advantageously be done as a marketing tool, in lieu of or in addition to shipping the business cards 21 in the ordinary new card boxes. It is especially contemplated that the printer or distributor of the business cards could advertise that they distribute new business cards in this fashion.

Thus, specific embodiments and applications of a safety device system have been disclosed. It should be apparent, however, to those skilled in the art that many more modifications besides those already described are possible without departing from the inventive concepts herein. The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A device for storage and display of an article, comprising:
a sheet adapted for insertion of an article;
an article to be placed into the sheet of the storage and display device; and
a plurality of pockets contained on the sheet for reception of an article within the pockets of the sheet.

2. The device of claim 1 further comprising:
the sheet wherein the sheet is constructed from vinyl.

3. The device of claim 1 further comprising:
the sheet wherein the sheet is constructed of plastic.

4. The device of claim 1 further comprising:
the sheet wherein the sheet is constructed of any suitable durable material wherein the material is transparent to allow for display and identification of the article contained within the pocket of the sheet.

5. The device of claim 1 further comprising:
the article to be placed in the pocket of the sheet is a business card.

6. The device of claim 1 further comprising:
the article to be placed in the pocket of the sheet is a pen, pencil, eraser or other article.

7. The device of claim 1 further comprising:
a plurality of side holes on an edge of the sheet whereby the sheet is insertable into a standard three ring binder.

8. The device of claim 1 further comprising:
an inside edge and an outside edge of the sheet wherein the outside edge of the sheet has a pocket located in close proximity thereto whereby when an article is inserted into the pocket, the article will extend outward, away from the outside edge of the sheet.

9. The device of claim 1 further comprising:
a plurality of pockets wherein at least one pocket is located within close proximity to an outside edge of the pocket whereby with insertion of an article, the article will extend outwardly from the outside edge of the pocket and extend away from the outside edge of the sheet and thereby act as a tab for the sheet.

10. The device of claim 1 wherein the plurality of pockets have an expansion means to accommodate larger articles.

11. The device of claim 1, wherein the pockets of the sheet may be configured in a plurality of configurations including horizontal placement, vertical placement and diagonal placement.

12. A method of using a business card holder, the method comprising the steps of:
providing a business card holder sheet adapted for insertion of an article wherein the sheet is constructed of vinyl and further wherein the sheet is transparent in nature;
producing an article to be placed into the sheet of the business card holder; and
providing a plurality of pockets contained on the sheet for reception of an article within the pockets of the sheet.

13. The method of claim 12 further comprising the step of:
providing a plurality of pockets wherein at least one pocket is located within close proximity to an outside edge of the pocket whereby with insertion of an article, the article will extend outwardly from the outside edge of the pocket and extend away from the outside edge of the sheet and thereby act as a tab for the sheet.

14. The method of claim 12 further comprising the step of:
providing an inside edge and an outside edge of the sheet wherein the outside edge of the sheet has a pocket located in close proximity thereto whereby when an article is inserted into the pocket, the article will extend outward, away from the outside edge of the sheet.

15. The method of claim 12 further comprising the step of:
providing an expansion means for the pockets of the sheet whereby the expansion means allows for insertion of larger articles or a plurality of articles into the pockets.

16. The method of claim 12 further comprising the step of:
inserting business cards into the pockets of the sheet of the business card holder.

17. The method of claim 12 further comprising the step of:
providing a plurality of pockets wherein at least one pocket is located within close proximity to an outside edge of the pocket whereby a business card is inserted into the pocket in close proximity to the outside edge of the sheet wherein the business card extends outwardly from the outside edge of the pocket and extend away from the outside edge of the sheet and thereby act as a tab for the sheet.

18. The method of claim 12 further comprising the step of:
inserting a plurality of business cards into a pocket on the sheet.

19. The method of claim 12 further comprising the step of:
removing a business card from the pocket when desired by the individual.
